(19) United States
(12) Patent Application Publication
(10) Pub. No.: US 2020/0290051 A1
(43) Pub. Date: Sep. 17, 2020

(54) GENE AMPLIFICATION DEVICE

(71) Applicant: SHIMADZU CORPORATION, Kyoto-shi (JP)

(72) Inventors: Kenji Ninomiya, Kyoto-shi (JP); Masamitsu Shikata, Kyoto-shi (JP); Naoko Takaoka, Kyoto-shi (JP); Shinichiro Kobayashi, Kyoto-shi (JP)

(73) Assignee: SHIMADZU CORPORATION, Kyoto-shi (JP)

(21) Appl. No.: 16/352,972

(22) Filed: Mar. 14, 2019

(51) Int. Cl. B01L 7/00; B01L 3/00

(52) U.S. Cl. CPC B01L 7/52; B01L 2300/0829; B01L 3/50851

(57) ABSTRACT

To improve a sealing property of a reaction container over a period before and after implementing gene amplification processing. A gene amplification device includes: a reaction container holder having a container insertion part into which a main body of a reaction container including the main body and a lid attached to an upper portion of the main body is inserted, the reaction container holder having a function of raising and lowering a temperature of the reaction container inserted into the container insertion part; and a heat seal part disposed near an contacting portion between the main body and the lid of the reaction container inserted into the container insertion part of the reaction container holder, the heat seal part heating a temperature of the contacting portion to a temperature higher than a heatproof temperature of the main body or the lid of the reaction container.

### TECHNICAL FIELD

The present invention relates to a gene amplification device that performs gene amplification by repeatedly heating and cooling a reaction container housing a gene.

### BACKGROUND ART

A PCR (polymerase chain reaction) method is known as a technique for amplifying a gene. In the PCR method, a reagent is added to a specimen containing DNA, and the DNA is amplified by periodically raising and lowering a temperature of the mixture. In order to carry out such a PCR method, a gene amplification device (also referred to as a thermal cycler) that houses a reaction container containing a specimen and a reagent and executes gene amplification processing for periodically performing heating and cooling of the reaction container has been proposed and also implemented (see, for example, Patent Document 1).

As disclosed in Patent Document 1, the gene amplification device includes a main body provided with a reaction container holder having a plurality of container insertion parts for inserting the reaction containers therein and a cover attached to the main body so as to be openable and closable. The reaction container holder is constituted by a heat conductive block, and a Peltier element for raising and lowering a temperature of the reaction container holder is provided in the main body. The cover is provided with a heat lid which has functions of pressing a lid attached to an upper surface of a main body of the reaction container when the cover is closed and heating the lid of the reaction container to a predetermined temperature.

By providing the heat lid in the cover, when the cover is closed, the lid is pressed toward the main body by the heat lid, a sealing property of the reaction container is improved, and evaporation of a reaction liquid to the outside of the reaction container is prevented. Further, by heating the lid of the reaction container by the heat lid before the gene amplification processing is carried out, water vapor generated by the gene amplification processing is prevented from condensing on the lid.

### PRIOR ART DOCUMENT

### Patent Document

Patent Document 1: Japanese Translation of PCT Publication No. 2016-519614

### SUMMARY OF THE INVENTION

### Problems to be Solved by the Invention

As described above, the lid is attached to the upper portion of the main body of the reaction container installed in the gene amplification device, and the lid is heated to the predetermined temperature while being pressed by the heat lid. Accordingly, evaporation of the reaction liquid and dew condensation when the gene amplification processing is carried out are prevented. However, in such a conventional configuration, it has been found that evaporation of the reaction liquid to the outside of the reaction container is not completely prevented in some cases.

When the reaction liquid evaporates from the reaction container, an amount of the reaction liquid varies when the gene amplification processing is started and when it ends, and a reaction state in the reaction container changes. Alternatively, pressure applied by a plate becomes nonuniform among a plurality of reaction containers installed in the reaction container holder, so that an amount of evaporation of the reaction liquid becomes nonuniform. Accordingly, the amount of the reaction liquid in each reaction container varies, and the reaction cannot be compared accurately.

In addition, in the gene amplification processing, the reaction container is heated to a high temperature of about 95° C. to thermally deform the reaction container, sealability between the main body and the lid of the reaction container after completion of the gene amplification processing worsens, and the lid is easily detached from the main body in many cases. If the lid of the reaction container is easily detached from the main body, there is also a problem that a gene amplification product in the reaction container leaks to the outside, causing environmental pollution and contamination.

Therefore, the present invention aims at improving a sealing property of a reaction container over a period before and after implementing gene amplification processing.

### Solution to the Problems

A gene amplification device according to the present invention includes: a reaction container holder having a container insertion part into which a main body of a reaction container including the main body and a lid attached to an upper portion of the main body is inserted, the reaction container holder having a function of raising and lowering a temperature of the reaction container inserted into the container insertion part; and a heat seal part disposed near an contacting portion between the main body and the lid of the reaction container inserted into the container insertion part of the reaction container holder, the heat seal part heating a temperature of the contacting portion to a temperature higher than a heatproof temperature of the main body or the lid of the reaction container.

A material of the main body and the lid of the reaction container is a resin such as polypropylene. When the heat seal part disposed near the contacting portion between the main body and the lid reaches a temperature higher than the heatproof temperature of the material of the main body or the lid, the resin at the contacting portion is thermally deformed. Thus, the main body and the lid are adhered to each other, and the reaction container is heat-sealed. Hereinafter, an operation of heating the heat seal part to a temperature higher than the heatproof temperature of the main body or the lid of the reaction container to heat-seal the contacting portion between the main body and the lid is referred to as a “heat sealing operation”.

Since the heat seal part heats the contacting portion between the main body and the lid of the reaction container, as long as the heat seal part can perform its function, it may be provided on the reaction container holder side or on a heat lid side. However, from the viewpoint of preventing evaporation of a reaction liquid inside the reaction container and thermal deformation of the main body, it is not desirable to heat the entire reaction container holder to a temperature higher than the heatproof temperature of the main body or the lid of the reaction container. Accordingly, when the heat seal part is provided on the reaction container holder side, it is necessary to perform a temperature raising operation of the heat seal part independently of a temperature raising and lowering operation of the reaction container holder, and it is necessary that the heat seal part and the reaction container holder are thermally separated. Thus, it is difficult to realize the heat seal part with a simple structure.

Therefore, it is preferable that the heat seal part in the present invention is provided as a part of the heat lid. The heat lid is disposed above the reaction container holder holding the reaction container in the container insertion part to be in contact with the lid of the reaction container, and has a function of heating a temperature of the lid to a predetermined temperature. As described above, the heat lid is provided to contact with the lid of the reaction container installed in the reaction container holder to heat the lid. Therefore, if the part of the heat lid is disposed near the contacting portion between the main body and the lid of the reaction container, only by heating the heat lid to a temperature higher than the heatproof temperature of the main body or the lid, the heat seal part can be realized without providing a new heater or the like, and an increase in cost can be suppressed. Since the heat lid is in contact with the lid of the reaction container and is not in direct contact with the main body, evaporation of the reaction liquid or thermal deformation of the main body by heating the main body more than necessary is prevented.

An example of a configuration for realizing the heat seal part as a part of the heat lid is described as follows: the heat lid is provided with a recess, on a lower surface, fitted with the lid of the reaction container projecting upward from the container insertion part of the reaction container holder, and a part of the heat lid is disposed near the contacting portion between the main body and the lid of the reaction container, when the lid of the reaction container is fitted into the recess. By adopting such a configuration, it is possible to realize the heat seal part at low cost.

In addition, in the conventional gene amplification device, it is general that a lower surface of the heat lid is a flat surface, and the lids of the plurality of reaction containers are pressed against the flat surface. Accordingly, there is a problem that force pressing the lids tends to become nonuniform.

On the other hand, when the recess for fitting with the lid of the reaction container is provided on the lower surface of the heat lid, the heat lid can stably and uniformly press the lid of the reaction container toward the main body, and it is possible to further improve a sealing property of the reaction container.

In addition, the gene amplification device of the present invention may be configured to automatically perform the above heat sealing operation. Specifically, a controller for controlling a temperature rising operation of the heat lid may be provided, and the controller may have a function of executing a heat sealing operation for raising a temperature of the heat lid to a temperature higher than the heatproof temperature of the main body or the lid of the reaction container, in a state in which the part of the heat lid is disposed near the contacting portion between the main body and the lid of the reaction container.

In the above case, it is preferable that the controller is configured to execute the heat sealing operation before starting gene amplification processing. Then, sealing of the reaction container is maintained over a period before and after the gene amplification processing, and evaporation and leakage of the reaction liquid are prevented.

The controller may also control a temperature raising and lowering operation of the reaction container holder together with the temperature raising operation of the heat lid. In that case, it is preferable that a temperature of the reaction container holder is not raised during execution of the heat sealing operation. As a result, evaporation of the reaction liquid during the heat sealing operation is suppressed.

### Effects of the Invention

A gene amplification device according to the present invention includes a heat seal part disposed near an contacting portion between a main body and a lid of a reaction container and for heating a temperature of the contacting portion to a temperature higher than a heatproof temperature of the main body or the lid. Accordingly, the contacting portion between the main body and the lid of the reaction container can be heat-sealed. By heat-sealing the contacting portion between the main body and the lid of the reaction container, a sealing property of the reaction container is greatly improved, and evaporation and leakage of a reaction liquid from the reaction container can be prevented.

### BRIEF DESCRIPTION OF THE DRAWINGS

FIG. 1 is a schematic configuration diagram showing an embodiment of a gene amplification device.

FIG. 2 is a sectional view showing a reaction container installed in the gene amplification device in the embodiment.

FIG. 3 is a sectional view showing a heat lid in the embodiment.

FIG. 4 is a sectional view showing a state during a heat sealing operation and during gene amplification processing in the embodiment.

### EMBODIMENT OF THE INVENTION

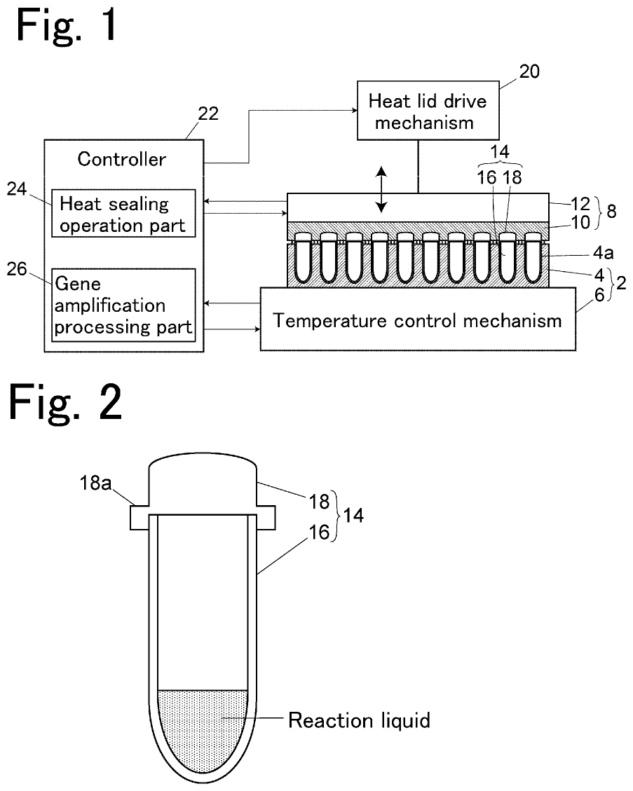

Hereinafter, an embodiment of a gene amplification device according to the present invention will be described with reference to FIGS. 1 to 4.

As shown in FIG. 1, the gene amplification device of this embodiment includes a reaction container holder 2, a heat lid 8, a heat lid drive mechanism 20, and a controller 22. A gene to be amplified is accommodated in a reaction container 14 together with a reagent, and the reaction container 14 is placed in the reaction container holder 2. The heat lid 8 that can move up and down is provided above the reaction container holder 2. The heat lid 8 is moved up and down by the heat lid drive mechanism 20 above the reaction container holder 2.

The reaction container holder 2 is constituted by a heat transfer block 4 and a temperature control mechanism 6. The heat transfer block 4 is provided with a plurality of container insertion parts 4a each consisting of a hole opened upward, and a main body 16 of the reaction container 14 is inserted into the container insertion part 4a. The temperature control mechanism 6 is constituted by, for example, a Peltier element and has a function of raising and lowering a temperature of the heat transfer block 4.

As shown in FIG. 2, the reaction container 14 is installed in the reaction container holder 2 in a state in which a lid 18 is attached to an upper portion of the main body 16. A recess that fits with an upper end of the main body 16 is provided on a lower surface of the lid 18, and the upper end of the main body 16 is fitted into the recess, thereby sealing an upper opening of the main body 16 and preventing evaporation and leakage of a reaction liquid contained in the main body 16. In the lid 18 of the reaction container 14 shown in this embodiment, a flange 18a extending in a circumferential direction is provided at a lower end. The recess for fitting the upper end of the main body 16 is provided inside the flange 18.

As shown in FIG. 1, when the reaction container 14 is installed in the container insertion part 4a of the reaction container holder 2, although the main body 16 of the reaction container 14 is accommodated in the container insertion part 4a, the lid 18 mounted on the upper portion of the main body 16 projects upward from an upper surface of the heat transfer block 4.

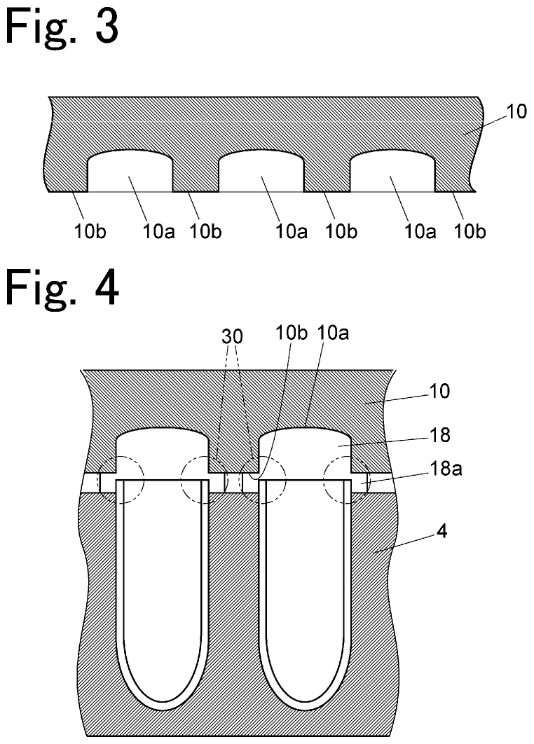

The heat lid 8 is composed of a heat transfer block 10 and a heating mechanism 12 such as a heater for heating the heat transfer block 10. As shown in FIG. 3, on a lower surface of the heat transfer block 10, a recess 10a to be engaged with the lid 18 of the reaction container 14 projecting upward from the upper surface of the heat transfer block 4 is provided. When gene amplification processing is performed, the heat lid 8 is descended from above the reaction container holder 2 by the heat lid drive mechanism 20, and the lid 18 is fitted into the recess 10a of the heat transfer block 10 to be in a state of FIG. 1. At this time, a surface 10b (see FIG. 3) around each recess 10a on the lower surface of the heat transfer block 10 is in contact with an upper surface of the flange 18a provided on the lid 18 of the reaction container 14.

Since the lid 18 of the reaction container 14 is fitted into the recess 10a of the heat transfer block 10 and further pressed toward the main body 16 by the heat lid 8, as shown in FIG. 4, an inner surface of the recess 10a and an outer surface of the lid 18 are brought into close contact with each other, and the surface 10b around the recess 10a and the upper surface of the flange 18a are brought into close contact with each other. Thus, the lid is stably and uniformly pressed toward the reaction container holder 2.

In a state shown in FIG. 4, a part of the heat transfer block 10 of the heat lid 8 is disposed in the vicinity of an contacting portion 30 between the main body 16 and the lid 18 indicated by a two-dot chain line circle. In this state, when the temperature of the heat transfer block 10 is raised to a temperature higher than a heatproof temperature of the main body 16 or the lid 18, a resin of the contacting portion 30 is thermally deformed, and the main body 16 and the lid 18 are bonded and heat-sealed. A main material of the main body 16 and the lid 18 of the reaction container 14 is a resin such as polypropylene. When the main material of the main body 14 and the lid 18 is polypropylene, the heatproof temperature of the main body 14 and the lid 18 is 121° C. Therefore, when the temperature of the heat transfer block 10 is raised to a temperature higher than 121° C. (for example, 125° C.), heat sealing of the reaction container 14 can be performed.

The part of the heat transfer block 10 disposed in the vicinity of the contacting portion 30 of the reaction container 14 forms a heat seal part for performing heat sealing of the contacting portion 30 of the reaction container 14. An operation of heat-sealing the reaction container 14 in this manner is called a heat sealing operation.

Returning to FIG. 1, operations of the temperature control mechanism 6 of the reaction container holder 2, the heating mechanism 12 of the heat lid 8, and the heat lid drive mechanism 20 are controlled by the controller 22. The controller 22 includes a heat sealing operation part 24 and a gene amplification processing part 26. The controller 22 can be realized by a computer dedicated to this gene amplification device or a general-purpose computer. The heat sealing operation part 24 and the gene amplification processing part 26 are functions realized by a central processing element (CPU) executing a program stored in a storage device provided in the computer that realizes the controller 22.

The heat sealing operation part 24 executes the above-described heat sealing operation at a timing, for example, before executing the gene amplification processing to be described later. In the heat sealing operation, an output of the heating mechanism 12 is controlled based on a signal from a temperature sensor (not shown) attached to the heat transfer block 10 so that the temperature of the heat transfer block 10 becomes a preset temperature (for example, 125° C.) as a heat sealing operation temperature. When this heat sealing operation is executed, the operation of the temperature control mechanism 6 may be turned off.

The gene amplification processing part 26 starts the gene amplification processing when there is an input, from a user, to the effect that the gene amplification processing should be started. Normally, the user installs the reaction container 14 in the reaction container holder 2 and inputs the start of the gene amplification processing at a stage of closing a device cover (not shown). When the start of the gene amplification processing is input, the gene amplification processing part 26 controls the heat lid drive mechanism 20 to lower the heat lid 8 to be in the state of FIG. 1.

In a case of the conventional gene amplification device, the temperature control mechanism 6 is controlled in this state to start the gene amplification processing for cyclically raising and lowering the temperature of the heat transfer block 4. In this embodiment, however, since the controller 22 is provided with the heat sealing operation part, the heat sealing operation is executed before the gene amplification processing is started. By this heat sealing operation, the contacting portion 30 between the main body 16 and the lid 18 of the reaction container 14 is heat-sealed, and a sealing property of the reaction container 14 is improved. In the heat sealing operation, the lid 18 is thermally deformed by being heated to a temperature higher than its heatproof temperature, but there is no influence on the reaction liquid in the main body 16.

Note that, in the embodiment described above, the part of the heat lid 8 (the heat transfer block 10) forms the heat seal part, but the heat seal part may be provided separately from the heat lid 8. In short, a heat seal part can be realized near the contacting portion 30 (see FIG. 4) between the main body 16 and the lid 18 of the reaction container 14 installed in the reaction container holder 2, as long as the contacting portion 30 can be heated to a temperature higher than the heatproof temperature of the main body 16 or the lid 18. However, when the heat transfer member 4 of the reaction container holder 2 is heated to a temperature higher than the heatproof temperature of the reaction container 14, there are problems such as evaporation of the reaction liquid and thermal deformation of the main body 16. Thus, it is not possible to realize a heat seal part while a structure of the conventional gene amplification device is maintained.

### DESCRIPTION OF REFERENCE SIGNS

2: Reaction container holder

4, 10: Heat transfer block

6: Temperature control mechanism

8: Heat lid

10a: Recess

12: Heating mechanism

14: Reaction container

16: Main body

18: Lid

20: Heat lid drive mechanism

22: Controller

24: Heat sealing operation part

26: Gene amplification processing part

30: Contacting portion

1. A gene amplification device comprising:
a reaction container holder including a container insertion part into which a main body of a reaction container including the main body and a lid attached to an upper portion of the main body is inserted, the reaction container holder having a function of raising and lowering a temperature of the reaction container inserted into the container insertion part; and
a heat seal part for heating a temperature of an contacting portion between the main body and the lid of the reaction container inserted into the container insertion part of the reaction container holder to a temperature higher than a heatproof temperature of the main body or the lid of the reaction container.

2. The gene amplification device according to claim 1, wherein
the heat seal part is a part of a heat lid, and
the heat lid is configured to dispose above the reaction container holder holding the reaction container in the container insertion part to be in contact with the lid of the reaction container, and to heat the lid to a predetermined temperature.

3. The gene amplification device according to claim 2, wherein the heat lid has a recess, on a lower surface, fitted with the lid of the reaction container projecting upward from the container insertion part of the reaction container holder, and has, as the heat seal part, a portion disposed near the contacting portion between the main body and the lid of the reaction container, when the lid of the reaction container is fitted into the recess.

4. The gene amplification device according to claim 3, the gene amplification device comprising a controller that controls a temperature raising operation of the heat lid, wherein
the controller is configured to execute a heat sealing operation for raising a temperature of the heat lid to a temperature higher than the heatproof temperature of the main body or the lid of the reaction container, in a state in which the heat seal part of the heat lid is disposed near the contacting portion between the main body and the lid of the reaction container.

5. The gene amplification device according to claim 4, wherein the controller is configured to execute the heat sealing operation before starting gene amplification processing.

6. The gene amplification device according to claim 4, wherein the controller is configured to control a temperature raising and lowering operation of the reaction container holder so as not to raise a temperature of the reaction container holder during execution of the heat sealing operation.

7. The gene amplification device according to claim 5, wherein the controller is configured to control a temperature raising and lowering operation of the reaction container holder so as not to raise a temperature of the reaction container holder during execution of the heat sealing operation.
